(19) United States
(12) Patent Application Publication
(10) Pub. No.: US 2026/0184027 A1
(43) Pub. Date: Jul. 2, 2026

(54) METHOD FOR PRODUCING A VANE MADE FROM COMPOSITE MATERIAL

(71) Applicant: SAFRAN, Paris (FR)

(72) Inventors: Naoufel BEN SALEM, Moissy-Cramayel (FR); Foucault DE FRANCQUEVILLE, Moissy-Cramayel (FR); Remi Roland Robert MERCIER, Moissy-Cramayel (FR)

(21) Appl. No.: 18/857,130

(22) PCT Filed: Apr. 11, 2023
(86) PCT No.: PCT/FR2023/050516

§ 371 Date: Oct. 15, 2024

(30) Foreign Application Priority Data
Apr. 21, 2022 (FR) 2203683

(51) Int. Cl. B29C 70/42; B29B 11/16; B29C 53/04; B29C 70/38; B29K 61/00; B29K 63/00; B29K 79/00; B29K 105/08; B29K 105/20; B29L 31/08; B29L 31/30

(52) U.S. Cl. CPC B29C 70/42; B29B 11/16; B29C 53/04; B29C 70/382; B29K 2061/00; B29K 2063/00; B29K 2079/085; B29K 2105/0872; B29K 2105/20; B29L 2031/08; B29L 2031/3076

(57) ABSTRACT

A method for producing a blade made from composite material, including the following steps: (a) successively stacking several layers of fibres to form a fibrous blank having first and second portions connected to one another in a continuous manner; (b) shaping the fibrous blank by folding along a line so as to form, on either side of the line, lower and upper skins of a fibrous preform of a blade airfoil, the leading edge, or alternatively the trailing edge, of the airfoil being located at, and along, this line; and (d) densifying the fibrous preform with a resin to form the blade made from composite material.

### TECHNICAL FIELD OF THE INVENTION

This invention relates to the general field of producing vanes for turbomachines, in particular for aircrafts.

### TECHNICAL BACKGROUND

The prior art includes in particular the documents GB-A-1302857, EP-A1-3542999 and US-A1-4626172.

The turbomachines are known, in particular double flow turbomachines, comprising a fan arranged upstream of a gas generator depending on the circulation of the gases in the turbomachine. The gas generator is housed in an internal annular casing, while the fan is housed in an outer annular casing, generally secured to a nacelle. The fan generates a primary flux or hot flux circulating in a primary duct passing through the gas generator, and a secondary flux or cold flux circulating in a secondary duct around the gas generator.

The fan comprises fan vanes each with a free end facing the outer casing so as to compress an incident air flow at least in the secondary duct and, preferably, also in the primary duct.

A turbomachine vane typically comprises an aerodynamically shaped blade. The blade comprises a pressure side face and a suction side face joined together by a leading edge and a trailing edge of the blade. The vanes can be made of metal or of a composite material, such as an organic matrix composite, in particular to reduce their weight.

A commonly used composite material comprises a fibrous preform embedded in a polymeric resin. The fibrous preform can be produced by three-dimensional (3D) weaving or can be obtained by stacking (or draping) and superimposing several layers/plies of fibres (for example in the form of strips or ribbons). The resin can be injected into the fibrous preform or the fibrous preform can be pre-impregnated with the resin (also known as “prepreg”).

The stacking of fibre layers can be done manually or automatically by a suitable machine, in particular according to the AFP technique (Automated Fiber Laying), the ATL technique (Automated Tape Laying) or the P&P technique (Pick&Place for pick-and-place system).

One method for producing vanes made from composite material is to produce a pressure side skin from a first fibrous preform to form the pressure side of the blade, then to produce a suction side skin from a second fibrous preform to form the suction side surface of the blade. The first and second fibrous preforms are obtained by successively stacking several fibre layers. The opposite ends of the pressure side and suction side skins are then fixed together to form the leading edge and trailing edge of the blade, after densification with a polymer resin to obtain the final vane. Another method for producing vanes made from composite material is to stack the fibre folds to produce a fibrous preform forming a skin intended to form the pressure side to the suction side of the blade. The opposite ends of the skin are then fixed together. For example, the ends of the skin(s) can be fixed by gluing or directly by polymerisation of the resin during densification.

Fixing the pressure side and suction side skins in this way has the disadvantage of being a weak connection that can easily weaken the leading edge and trailing edge, particularly in the event of shocks or impact from a foreign object during operation. This can often dissuade designers from making composite vanes by stacking fibre layers.

To overcome this disadvantage, it may be necessary to stack layers with continuous fibres to form a strong bond between the pressure side and suction side of the blade of the vane.

To achieve this, the stacking of fibre layers can be made in the form of a spar on a reinforcement support (such as a mandrel). However, the aerodynamic shape of the blade (i.e., a twisted shape) can make it difficult, if not impossible, to remove the reinforcement support inside the spar. The use of a reinforcement support that can be cracked or dismantled, is not reliable particularly during a shaping step (also known as “forming”) of the spar. This is because the crackable or removable support cannot withstand a compaction pressure exerted locally on the reinforcement support by an AFP technique deposition head. In addition, certain areas of the blade of the vane can be thin (for example with direct contact between the pressure side and suction side skins to form the trailing edge) to accommodate the reinforcement support. However, the absence of a reinforcement support (i.e. in a vacuum) may prevent the vane from being produced by stacking folds, particularly using an automated machine such as the AFP technique.

There is therefore a need to optimise the production of vanes made from composite material by stacking fibre layers, while ensuring good mechanical resistance of the vanes to impacts during operation.

### SUMMARY OF THE INVENTION

The present invention proposes a simple, effective and economical solution to this problem.

The invention proposes a method for producing a vane made from composite material for an aircraft turbomachine, the vane comprising a blade having a pressure side and a suction side interconnected by a leading edge and a trailing edge, the method comprising the following steps:
(a) successively stacking several fibre layers to form a fibrous blank,
(b) shaping said fibrous blank to obtain a fibrous preform of the blade, said fibrous preform comprising a pressure side skin and a suction side skin joined together and configured to form, respectively, the pressure side and suction side of the blade, and
(d) densifying said fibrous preform with a resin to form the vane made from composite material.

According to the invention, the fibrous blank comprises first and second portions continuously joined together in step (a).

In addition, step (b) comprises folding the fibrous blank along a line extending between said first and second portions so as to form, on either side of the folding line, said pressure side and suction side skins.

The leading edge, or alternatively the trailing edge, of the blade is located at and along this folding line, and edges of the pressure side and suction side skins, opposite this folding line, being joined together to form the leading edge, or alternatively the trailing edge, of the blade.

Thus, this solution allows to achieve the above-mentioned objective. Generally speaking, the method according to the invention allows us to simplify and optimise the manufacture of a vane made from composite material using the technique of stacking of fibre layers.

In particular, the step (a) of the method enables the fibre layers to be stacked to form a fibrous blank with continuous fibres. The step (b) of folding this fibrous blank along a folding line brings together the pressure side and suction side skins of the fibrous preform and forms the leading edge, or alternatively the trailing edge, of the blade of the vane at the level of this folding line. The folding line thus allows to form a strong connection area between the pressure side and suction side skins, since this connection area is formed by continuous fibres.

Thus, the vane made from composite material produced by such a method has a strong bond, particularly at the leading edge and/or trailing edge, so as to reinforce the mechanical strength of the vane, particularly in the event of shocks or impact from a foreign body during operation.

According to the invention, the fibrous blank and/or the fibrous preform are formed on a surface of a support which is planar, U-curved or V-curved, wherein said surface of the support further comprises a U- or V-shaped projecting portion configured to define said folding line. The method comprises, in step (a), a step (i) of preforming at least part of the fibrous blank formed on said U- or V-shaped projecting portion of the support.

This preforming step (i) enables a so-called connection area to be preformed directly on the fibrous blank at the folding line, in particular before the fibrous blank is folded in step (b). This facilitates the folding of the fibrous blank and controls the dimensions of the connection area between the pressure side and suction side skins. As a result, the mechanical strength of the vane made from composite material is improved (particularly at the leading edge and/or trailing edge).

In the present application, a turbomachine vane may be ducted, as in the case of a fan for example, or may be unducted, as in the case of a propeller of an open-rotor type architecture for example.

The manufacturing method according to the invention may comprise one or more of the following characteristics, taken in isolation from one another or in combination with one another:
in step (a) or (b), the fibrous blank has a generally planar and/or U-shaped or V-shaped curvature;
step (a) is carried out manually or by machine;
step (d) comprises impregnating the fibrous preform with the resin and polymerising the resin by heat treatment;
the resin is injected into the fibrous preform before step (d), or the fibrous blank is previously impregnated with the resin;
the resin is thermosetting and is, for example, an epoxy resin;
the resin is thermoplastic, for example polyether ether ketone, polyaryl ether ketone or polyether imide;
it comprises a step (c) of adding at least one reinforcement insert into an internal space delimited by the pressure side and suction side skins of the fibrous preform, for example the reinforcement insert is made of foam, cellular material or composite material.
   step (b) is a step for forming the fibrous blank;
in step (b), folding the fibrous blank is carried out by compaction, for example with a pressure of between 300 and 800 Pascal;
in step (b), folding the fibrous blank is carried out by compaction with a vacuum, for example between −300 and −900 mBar (i.e., −30000 and −90000 Pascal);—step (b) is carried out at a predetermined temperature which May be variable depending on the resin chosen, for example the predetermined temperature is between 30° C. and 100° C., particularly in the case of fibre layers pre-impregnated with a thermosetting resin;
   the method comprises a step (i) of preforming at least part of the fibrous blank formed on said projecting portion;
   this step (i) is carried out during step (a);
the fibre layers each comprise glass fibres, carbon fibres, aramid fibres, polyamide fibres, ceramic fibres, metal fibres, oxide fibres, or a mixture of at least two of these fibres;
the reinforcement insert comprises a sealing envelope encapsulating the cellular material;
the cellular material of the reinforcement insert is chosen from a polymer foam, an aluminium foam, a metal nida and/or an aramid polymer;
the reinforcement insert can be produced by additive manufacturing;
the reinforcement insert can be made from a thermoplastic structure. The invention also relates to a vane made from composite material for an aircraft turbomachine, produced by a production method as described above.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic half-view of an aircraft turbomachine in axial section:

FIG. 2 is a schematic perspective view of a vane of the turbomachine of FIG. 1;

FIG. 3 is a block diagram of a production method according to the invention, for the vane made of composite material shown in FIG. 2;

FIG. 4a is a schematic cross-sectional view of a fibrous blank obtained by the production method of the invention;

FIG. 4b is a schematic cross-sectional view of the folded fibrous blank of FIG. 4a;

FIG. 5 is a schematic cross-sectional view of a fibrous preform obtained by the production method of the invention;

FIG. 6 is a schematic view of some of the steps in the production method of FIG. 3 according to a first embodiment, in which the method uses a generally planar support;

FIG. 7a is a schematic view of the generally planar support shown in FIG. 6, comprising a projecting portion according to a first variant;

FIG. 7b is a schematic view of the generally planar support shown in FIG. 6, comprising a projecting portion in a second variant;

FIG. 8 is a schematic view of part of the production method steps of FIG. 3 according to a second embodiment, in which the method uses a generally curved support;

FIG. 9a is a schematic view of the generally curved support of FIG. 8, comprising a projecting portion according to a first variant;

FIG. 9b is a schematic view of the generally curved support of FIG. 8, comprising a projecting portion according to a second variant;

FIG. 10 is a schematic view of some of the steps in the production method shown in FIG. 3, according to another embodiment;

FIG. 11a is a schematic view in axial section of a fibrous preform comprising a reinforcement insert according to a first variant;

FIG. 11b is a schematic axial sectional view of a fibrous preform comprising a reinforcement insert according to a second variant.

The elements having the same functions in the different embodiments have the same references in the figures.

### DETAILED DESCRIPTION OF THE INVENTION

By convention, in the following description, the terms “longitudinal” and “axial” refer to the orientation of structural elements extending in the direction of a longitudinal axis. The terms “radial” or “vertical” refer to an orientation of structural elements extending along a direction perpendicular to the longitudinal axis. The terms “inner” and “outer”, and “internal” and “external” are used in reference to a positioning with respect to the longitudinal axis. Thus, a structural element extending along the longitudinal axis comprises an inner face facing the longitudinal axis and an outer surface opposite its inner surface.

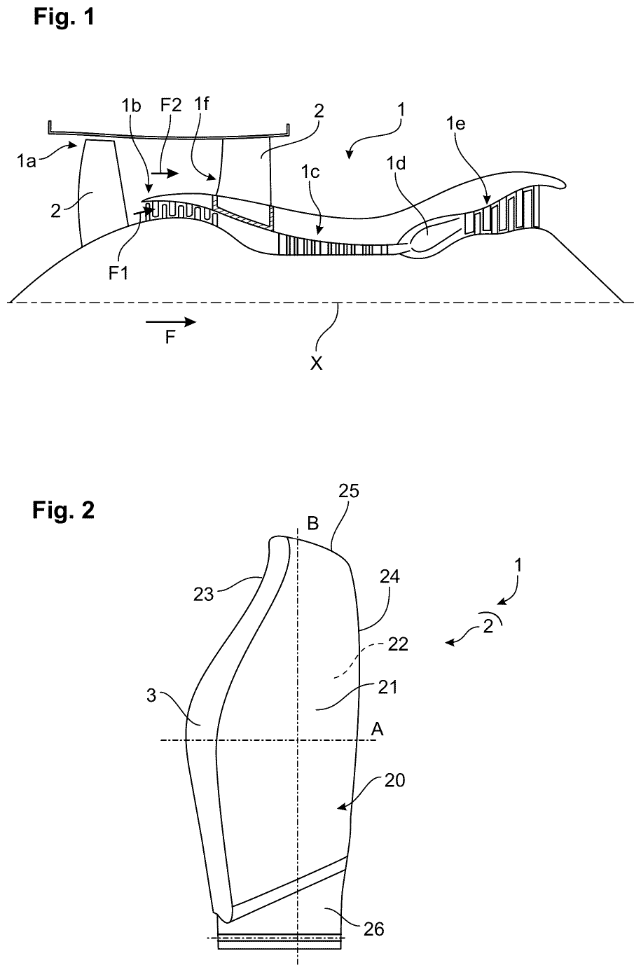

A turbomachine 1 of the ducted type, in particular for aircraft, is shown in FIG. 1, for example. The turbomachine 1 may be a turbojet engine or turboprop engine.

The turbomachine 1 extends around a longitudinal axis X. It comprises, from upstream to downstream in the direction of gas flow F along the longitudinal axis X, a fan 1a, at least one compressor such as a low-pressure compressor 1b and a high-pressure compressor 1c, a combustion chamber 1d, at least one turbine 1e such as a high-pressure turbine and a low-pressure turbine, and a nozzle (not shown).

The turbomachine 1 also comprises a stator vane 1f. The stator vane 1f rectifies the flow at the outlet of an upstream rotor to provide maximum thrust at the outlet of the turbomachine 1. In the particular example shown in FIG. 1, the stator vane 1f is located downstream of the fan 1a and rectifies a secondary flux F2.

The fan 1a allows the suction of an air flow divided into a primary flux F1 and a secondary flux F2. The primary flux F1 passes through a primary duct of the turbomachine 1, while the secondary flux F2 is directed towards a secondary duct surrounding the primary duct.

The primary flux F1 is compressed in the low-pressure compressor 1b and then in the high-pressure compressor 1c. The compressed air is then mixed with a fuel and burnt in the combustion chamber 1d. The gases formed by combustion pass through the high-pressure turbine and the low-pressure turbine. The gases escape finally through the nozzle whose cross-section allows the acceleration of these gases to generate the propulsion. The secondary flux F2 passes through the stator vane 1f, which accelerates the circulation speed of the secondary flux F2 to generate propulsion.

The fan 1a, the low-pressure compressor 1b, the high-pressure compressor 1c, the high-pressure and/or low-pressure turbine 1e and the stator vane 1f comprise vanes 2. The vanes 2 can be mobile (for example the vane in FIG. 2) in rotation about the longitudinal axis X, or fixed (for example the vane 2 called OGV for “Outlet Guide Vane” of the stator vane 1f in FIG. 1) in relation to the axis X.

The object of the invention is to produce a vane made of composite material for a turbomachine, in particular for an aircraft. In the following description, the vane of the invention will be described in the context of its application to the fan 1a of the turbomachine 1 of the FIG. 1.

However, the invention is not limited to the fan vane of a ducted turbomachine and can also be applied to other types of vanes made of composite material (such as the fixed or moving vanes of low-pressure compressors 1b and high-pressure compressors 1c, and the high-pressure and low-pressure turbines of the turbomachine 1). The invention can be applied to a propeller of an unducted turbomachine (e.g., an open-rotor architecture).

With reference to FIG. 2, each vane 2 extends along a longitudinal axis A (arranged horizontally in FIG. 2) and along an axis of elongation B (arranged vertically in FIG. 2). This axis A is substantially perpendicular to the axis B. The axis A is substantially parallel to the axis X of the turbomachine 1.

The vane 2 comprises a blade 20. The blade 20 comprises a pressure side 21 and a suction side 22 joined together by a leading edge 23 and a trailing edge 24. The blade 20 can have an aerodynamic profile to form the aerodynamic part of the vane 2. To achieve this, the blade 20 can have a curved profile of variable thickness between its leading edge 23 and its trailing edge 24. The blade 20 may comprise a first longitudinal end connected to a root 26 of the vane 2 and a second longitudinal end opposite the first longitudinal end. The second longitudinal end is free and configured to form a vane tip 25 (or head).

The vane 2 may also comprises a reinforcement or shield 3 to protect the leading edge 23, in the form of a metal foil. In the example, the shield 3 extends in height (relative to the axis A) and over a portion in length (relative to the axis B) of the pressure side face 21 and the suction side face 22 from the leading edge 23 of the blade 20.

As described earlier in the technical background to the invention, a vane made from composite material can be made by stacking fibre layers.

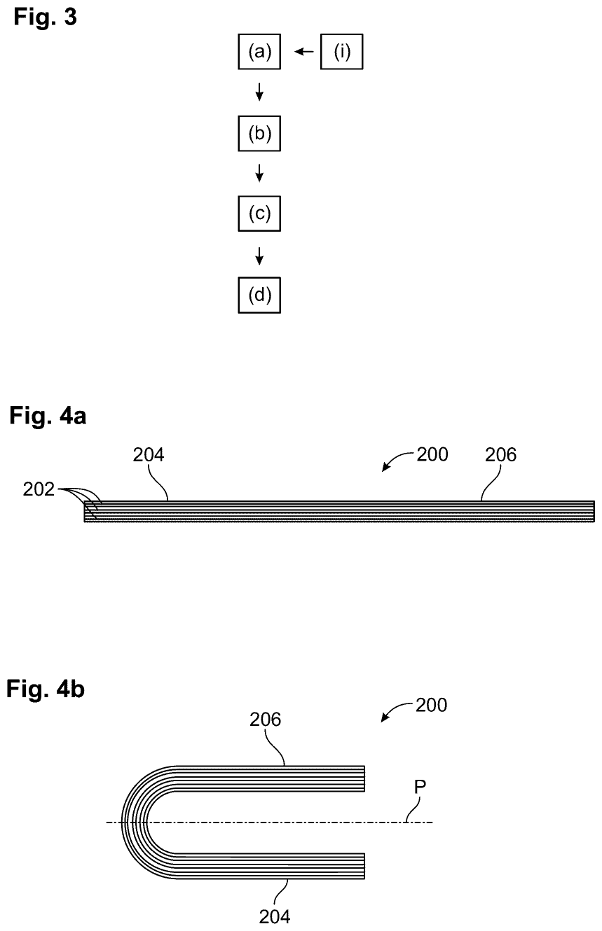

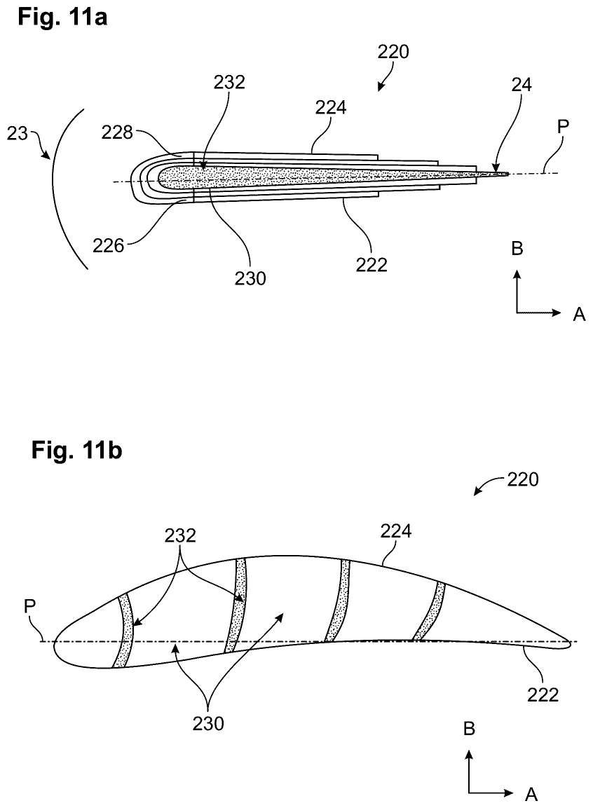

A method for producing the vane 2 according to the invention will now be described with reference to FIGS. 3 and 11b.

FIG. 3 shows a block diagram of an example of the method described in the invention.

Generally speaking, the method for producing the vane 2 may comprise the following steps:
(a) successively stacking several fibre layers 202 to form a fibrous blank 200,
(b) shaping this fibrous blank 200 to obtain a fibrous preform 220 of the blade 20, and
(d) densifying this fibrous preform 220 with a resin to form the vane 2 made from composite material.

One of the characteristics of the invention is that the fibrous blank 200 of step (a) comprises a first portion 204 and a second portion 206 continuously joined together. In other words, the first 204 and second 206 portions are integrally formed with continuous fibres. This reinforces the mechanical strength of the vane, in particular at the leading edge 23 and/or trailing edge 24 in the event of shocks or impact from a foreign body during operation.

By way of example, the fibre layers 202 comprise glass fibres, carbon fibres, aramid fibres, polyamide fibres, ceramic fibres, metal fibres, oxide fibres, or a mixture of at least two of these fibres.

The fibre layers 202 can be pre-impregnated with resin or be in a raw state (or dry fibres). “Raw fibres” or “dry fibres” refers to fibre layers 202 comprising fibres not previously impregnated with resin.

The fibre layers 202 may comprise a binder.

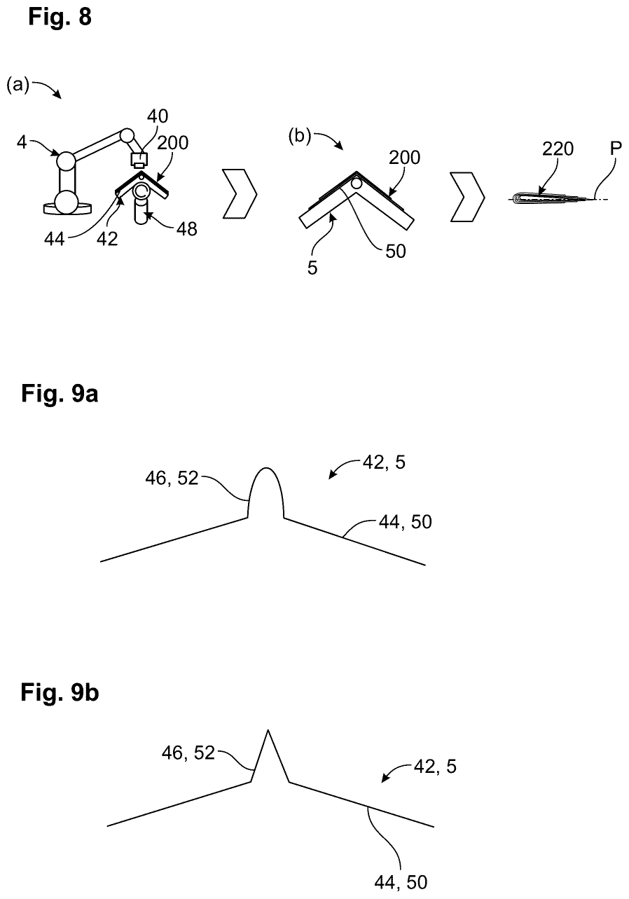

In the example shown in FIG. 4a, the fibrous blank 200 has a generally planar shape. Alternatively, the fibrous blank 200 can have a generally curved shape, in particular a U or V shape (FIG. 8). In particular, the curved shape of the fibrous blank 200 facilitates the formation of a folding line P in step (b), which is described below.

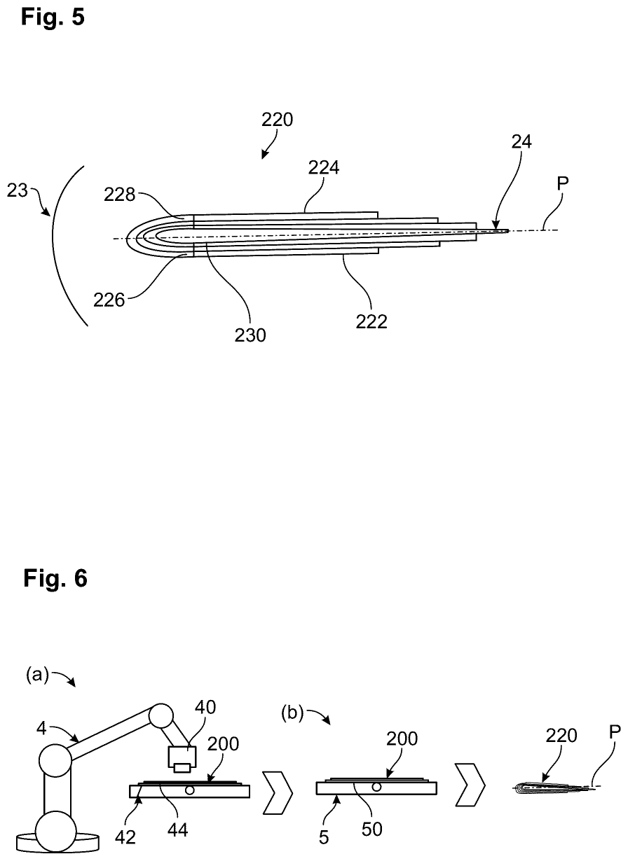

In particular, step (b) comprises bending the fibrous blank 200 along the so-called folding line P (FIG. 4b). This line P may be substantially parallel to the axis A. The folding line P extends between the first 204 and second 206 portions so as to form, on either side of this folding line P, pressure side 222 and suction side 224 skins of the fibrous preform 220 (FIG. 5).

As shown in the examples in FIGS. 4b and 5, the first 204 and second 206 portions are folded together to join the pressure side 222 and suction side 224 skins together. The first portion 204 can be configured to form the pressure side skin 222 and the second portion 206 can be configured to form the suction side skin 224 of the fibrous preform 220.

With reference to FIG. 5, the fibrous preform 220 of step (b) therefore comprises the pressure side skin 222 configured to form the pressure side 21, and the suction side skin 224 configured to form the suction side 22 of the blade 20. The pressure side 222 and suction side 224 skins are joined together, in particular along the folding line P.

The leading edge 23, or the trailing edge 24, is located at and along this folding line P.

The pressure side skin 222 may comprise a first edge 226 opposite the folding line P (in particular radially with respect to the line P). The suction side skin 224 may comprise a second edge 228 opposite the folding line P.

In the example shown in FIG. 5, the first 226 and second 228 edges are brought together to form the leading edge 23 located on the folding line P.

Advantageously, step (a) of the method can be carried out manually or by a machine 4. The machine 4 can be automated or mechanised. For example, step (a) can be carried out by an automated machine 4 using the AFP, ATL or P&P technique.

Step (b) of shaping the fibrous blank 200 can be carried out at a predetermined forming temperature. This forming temperature can be low, between 30° C. and 100° C., for example in the case of a fibre layer 202 pre-impregnated with a thermosetting resin. The forming temperature may vary depending on the polymerisation resin used. A heating system (e.g. an oven) can be used in step (b) to shape the fibrous blank by heating.

The folding in step (b) can be carried out by compaction at a predetermined pressure and/or a predetermined vacuum. By way of example, the fibrous blank 200 is compacted at a vacuum of between −300 and −900 mBar, for example in the case of a fibre layer 202 pre-impregnated with resin.

The pressure or vacuum of the compaction may vary depending on the resin material.

A pressure can be applied additionally or alternatively to the vacuum. In this case, the pressure of the compaction can be between 1 and 10 Bar, for example in the case of a fibre layer 202 pre-impregnated with resin.

The step (b) can be carried out in an oven, autoclave, press or any other tool suitable for folding the fibrous blank 200.

At the end of step (b) of the method, the pressure side 222 and suction side 224 skins of the formed fibrous preform 220 are joined together by the first and second edges 226, 228 forming the leading edge 23 (in the example of FIG. 5) or the trailing edge 24.

FIGS. 6, 8 and 10 illustrate, respectively, a first mode, a second mode and a third embodiment of the vane 2.

In the first embodiment of the method illustrated in FIG. 6, step (a) is carried out by the machine 4, in particular of the AFP type. To achieve this, the machine 4 comprises a head 40, referred to as a draping or stacking head, and a first support 42, referred to as a stacking support. The head 40 is used to successively deposit several fibre layers one on top of the other, in particular on a first surface 44 of the first support 42. In the example shown in FIG. 6, the first surface 44 is planar. The fibrous blank 200 obtained at the end of step (a) therefore has a planar shape.

Alternatively, the first surface 44 of the first support 42 is curved, in particular in a U or V shape (FIG. 8) to define the fibrous blank 200 with a curved U or V shape (FIG. 8).

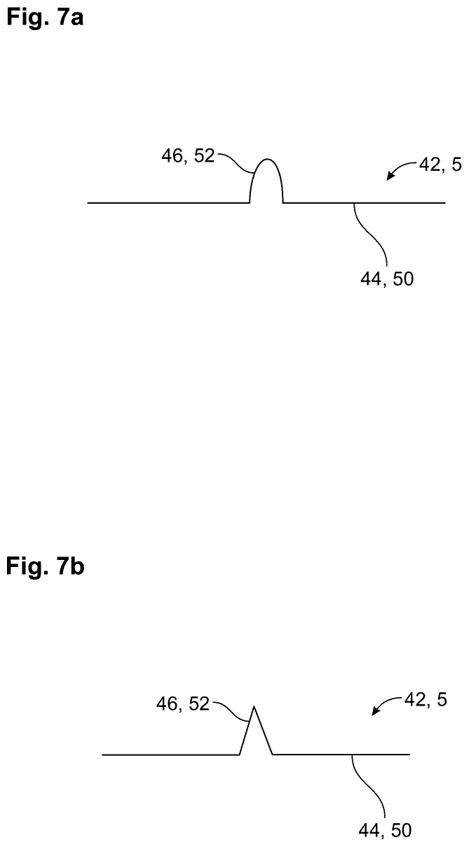

Advantageously, the first surface 44 may comprise a first projecting portion 46. This first projecting portion 46 defines the folding line P. In this way, the first projecting portion 46 can be configured to form the leading edge 23 and/or the trailing edge 21 of the blade 20. The first projecting portion 46 may be generally U-shaped (FIG. 7a) or V-shaped (FIG. 7b).

In step (b), the fibrous blank 200 can be mounted on a second surface 50 of a second support 5 known as a forming support. In the example shown in FIG. 6, the second surface 50 is planar. Alternatively, the second surface 50 of the second support 5 is, in particular, curved in a U or V shape (FIG. 8).

Advantageously, the second surface 50 may comprise a second projecting portion 52. This second projecting portion 52 defines the folding line P. In this way, the second projecting portion 52 can be configured to form the leading edge 23 and/or the trailing edge 21 of the blade 20. The second projecting portion 52 may be generally U-shaped (FIG. 7a) or V-shaped (FIG. 7b).

One and the same support 42, 5 can be used to carry out both steps (a) and (b), or conversely two different supports 42, 5 can be used to carry out steps (a) and (b) of the method of the invention.

At the end of step (b) in the example shown in FIG. 6, the fibrous preform 220 comprises pressure side 222 and suction side 224 skins joined together.

The second embodiment shown in FIG. 8 differs from the method of the first embodiment shown in FIG. 6 in that the first 42 and second 5 supports are used.

In the second embodiment, the first 44 and second 50 surfaces of the supports 42, 5 have a generally V-curved shape. Thus, the fibrous blank 200 obtained in step (a) has a V-shaped curvature.

The machine 4 may also comprise a holding member 48 (for example a cylindrical plate). In particular, this holding member 48 supports the V-shaped curvature of the first surface 44 of the first support 42.

As described with reference to FIGS. 7a and 7b, the first 44 surface of the first support 42 of the second embodiment may comprise the first projecting portion 46 (FIGS. 9a and 9b). Similarly, the second 50 surface of the second support 5 of the second embodiment may comprise the second projecting portion 52 (FIGS. 9b and 9b). The first 46 and second 52 projecting portions define the folding line P and also, in particular, the leading edge 23, or trailing edge 21, of the blade 20. The first 46 and second 52 projecting portions of the second embodiment may each be generally U-shaped (FIG. 9a) or V-shaped (FIG. 9b).

Alternatively (not illustrated in the figures), the first 44 and second 50 surfaces, respectively, of the first 42 and second 5 supports, are each U-curved to define the fibrous blank 200 with a U-curved shape. These first 44 and second 50 U-shaped curved surfaces may comprise first 46 and second 52 projecting portions, as described with reference to the first and second embodiments of the invention.

The method of the invention may comprise a step (i) of preforming at least part of the fibrous blank 200 formed on the first 46 or second 52 projecting portions from the support 42, 5, for example in a U or V shape. This step (i) may be carried out during or after step (a). This allows to preform the connection area directly (at the level of the folding line P) on the fibrous blank 200, before step (b) of folding the fibrous blank 200 to form the folded pressure side 222 and suction side 224 skins. In this way, the dimensions (shape, size, thickness, etc.) of the area where the pressure side 222 and suction side 224 skins are joined, at the level of the folding line P, are better controlled.

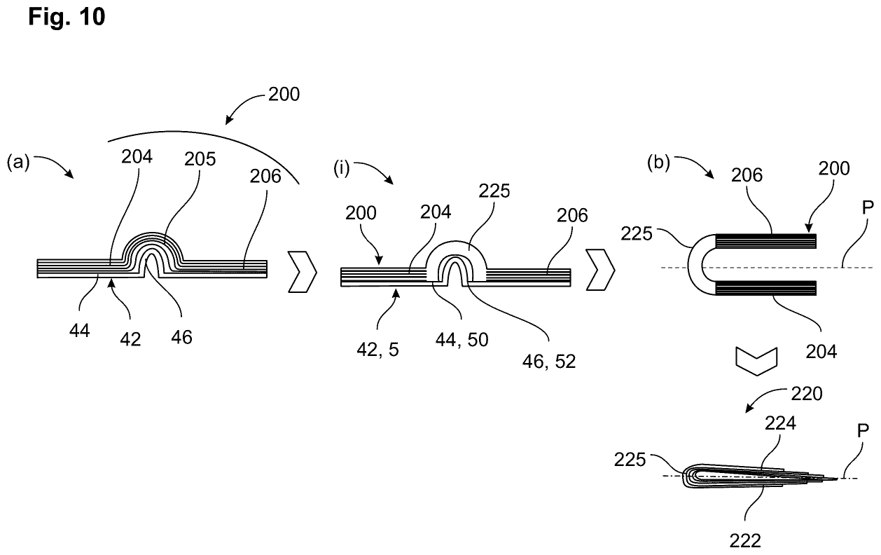

By way of example, FIG. 10 illustrates preforming step (i) after step (a) of stacking the fibre layers 202 and before folding the fibrous blank 200 in step (b). The fibrous blank 200 thus comprises a median portion 205 between the first 204 and second 206 portions. This median portion 205 is located at the folding line P, and configured to form the leading edge 23, or the trailing edge 24, of the blade 20. The U- or V-shape of the projecting portion 46, 52 of the support 42, 5 allows the median portion 205 to be compacted to form a so-called intermediate fibrous preform 225. The first 204 and second 206 portions of the fibrous blank 200 extend on either side of this intermediate preform 225. Then, in step (b), the first 204 and second 206 portions are folded together to form the fibrous preform 220.

The densification step (d) of the method can involve polymerizing the resin by heat treatment (or, in other words, curing the resin into a polymer matrix). To this end, the fibrous preform 220 can be impregnated with the resin beforehand, in particular in step (a) and/or step (i), during the production of the fibrous blank 200, 201, 203. For example, the head 40 of the machine 4 deposits rovings in the form of a mixture of fibres and resin in layers superimposed on one another to form the pre-impregnated fibrous blank. In this case, step (d) can be carried out in an autoclave, using a resin injection moulding technique similar to “SQRTM” (Same Qualified Resin Transfer Molding) or any other technique for polymerising a fibrous preform with a controlled geometry.

Alternatively, the densification step (d) of the method may comprise injecting resin into the fibrous preform 220, and polymerising the resin by heat treatment. To achieve this, the fibrous preform 220 comprises dry fibre layers 202. By way of example, the vane made from composite material can be produced using the RTM (Resin Transfer Molding) liquid resin injection molding technique. To do this, the fibrous preform 220 obtained in step (b) can be placed in a mould to be densified by a polymer matrix which consists of impregnating the fibrous preform 220 with an injected resin and polymerising the latter to obtain the final vane. The resin may be injected into the fibrous preform 220 before or at step (d).

The resin can be thermosetting, such as an epoxy resin.

The resin can be thermoplastic, such as polyether ether ketone, polyaryl ether ketone or polyether imide.

The method of the invention may further comprise a step (c) of adding at least one reinforcement insert 232 to an internal space 230 delimited by the pressure side 222 and suction side 224 skins of the fibrous preform 220. This insert is used in particular to hold the pressure side and suction side skins in place during densification step (d) of the fibrous preform.

The reinforcement insert 232 can be housed in the entire surface of the internal space 230 (FIG. 11a). Alternatively, the reinforcement insert 232 can be positioned at a few predefined points in the internal space 232 (FIG. 11b).

With reference to FIG. 11b, a number of reinforcement inserts 232 in the form of stiffeners extend radially (with respect to the line P or the axis A) between the pressure side 222 and suction side 224 skins.

The reinforcement insert 232 may be made of foam, cellular material or composite material. By way of example, the cellular material chosen from a polymer foam (e.g. polymethacrylic imide of the Rohacell® type), an aluminium foam, a metal nida and/or an aramid polymer (e.g. of the Nomex® type).

The reinforcement insert 230 may comprise a sealing envelope encapsulating the cellular material. This protects the cellular material, particularly during step (d). This sealing envelope can be made of a composite material.

The reinforcement insert 230 can be produced by additive manufacturing.

The reinforcement insert 230 can be made from a thermoplastic structure that can be injected between the pressure side 222 and the suction side 224 skins.

1. A method for producing a vane made from composite material for an aircraft turbomachine, the vane comprising a blade having a pressure side and a suction side interconnected by a leading edge and a trailing edge, the method comprising the following steps:
(a) successively stacking several fibre layers to form a fibrous blank,
(b) shaping said fibrous blank to obtain a fibrous preform of the blade, said fibrous preform comprising a pressure side skin and a suction side skin joined together and configured to form, respectively, the pressure side and the suction side of the blade, and
(d) densifying said fibrous preform with a resin to form the vane made from composite material,
wherein the fibrous blank comprises first and second portions continuously joined together in step (a),
in that step (b) comprises folding the fibrous blank along a line extending between said first and second portions so as to form, on either side of the folding line, said pressure side and suction side skins, and in that the leading edge, or alternatively the trailing edge, of the blade is located at the level of and along this folding line, and edges of the pressure side and suction side skins, opposite this folding line, being joined together to form the leading edge, or alternatively the trailing edge, of the blade;
in that the fibrous blank and/or the fibrous preform are formed on a surface of a support which is planar, U-curved or V-curved, said surface of the support further comprises a U- or V-shaped projecting portion configured to define said folding line;
and in that the method comprises, in step (a), a step (i) of preforming at least part of the fibrous blank formed on said U- or V-shaped projecting portion of the support.

2. The production method according to claim 1, wherein, in step (a) or (b), the fibrous blank has a generally planar and/or U-shaped or V-shaped curvature.

3. The production method according to claim 1, wherein step (a) is carried out manually or by a machine.

4. The production method according to claim 1, wherein step (d) comprises impregnating the fibrous preform with the resin and polymerizing the resin by heat treatment.

5. The production method according to claim 4, wherein the resin is injected into the fibrous preform prior to step (d), or the fibrous blank is previously impregnated with the resin.

6. The production method according to claim 4, wherein the resin is thermosetting, and is for example an epoxy resin.

7. The production method according to claim 4, wherein the resin is thermoplastic, and for example a polyether-ether-ketone resin, polyaryl ether ketone or polyether imide.

8. The production method according to claim 1, wherein the method comprises a step (c) of adding at least one reinforcement insert into an internal space delimited by the pressure side and suction side skins of the fibrous preform, for example the reinforcement insert is made of foam, of cellular material or of composite material.

9. The production method according to claim 8, wherein said reinforcement insert is made of cellular material, and this reinforcement insert comprises a sealing envelope encapsulating the cellular material.

10. The production method according to claim 8, wherein the reinforcement insert is produced by additive manufacturing.

11. The production method according to claim 1, wherein the fibre layers each comprise glass fibres, carbon fibres, aramid fibres, polyamide fibres, ceramic fibres, metal fibres, oxide fibres, or a mixture of at least two of these fibres.

12. The production method according to claim 1, wherein in step (b), folding the fibrous blank is carried out by compaction with a pressure of between 300 and 800 Pascal.

13. The production method according to claim 1, wherein in step (b), folding the fibrous blank is carried out by compaction with a vacuum of between −300 and −900 mBar.

14. The production method according to claim 1, wherein step (b) is carried out at a predetermined temperature of between 30° C. and 100° C. when the fibre layers are pre-impregnated with a thermosetting resin.
